(19) United States
(12) Patent Application Publication
(10) Pub. No.: US 2026/0220164 A1
(43) Pub. Date: Jul. 30, 2026

(54) Method for unsupervised analysis of a textual data set related to the execution of business processes

(71) Applicant: ORANGE, Issy-les-Moulineaux (FR)

(72) Inventors: Marwa ELLEUCH, Châtillon (FR); Philippe LEGAY, Châtillon (FR); Oumaima ALAOUI ISMAILI, Châtillon (FR)

(21) Appl. No.: 19/140,063

(22) PCT Filed: Dec. 18, 2023
(86) PCT No.: PCT/EP2023/086308

§ 371 Date: Jun. 17, 2025

(30) Foreign Application Priority Data
Dec. 19, 2022 (FR) FR2213866

(51) Int. Cl. G06F 16/31; G06F 40/232; G06F 40/247; G06F 40/30

(52) U.S. Cl. CPC G06F 16/313; G06F 40/232; G06F 40/247; G06F 40/30

(57) ABSTRACT

A method for analyzing a set of textual data, referred to as a set of verbatims, each verbatim having an ordered sequence of words. Such a method includes: determining recurrent word combinations in the verbatims, and identifying common patterns within the recurrent word combinations; identifying synonymy relationships between words of a same syntax function within the common patterns, and gathering the synonymous words of the same syntax function within same data structures, referred to as semantic entities; and determining typical actions according to the semantic entities, a typical action being representative of similar contexts of operations identifiable in the verbatims.

### TECHNICAL FIELD

The invention is in the field of automatic analysis of unstructured textual data. More particularly, the invention is directed, for example, to the analysis of textual data from logs of business applications.

### PRIOR ART

In many fields, and more particularly in the context of managing activities of a company, it is common for business applications to be used to collect textual data freely written by a user in natural language, for example within an entry zone of a form made available via a computer tool. As examples of such textual data, mention may be made in particular of verbatims of various points of contact (e.g. customers, employees, etc.) collected via customer relationship management applications, comments from incident escalation tickets, exchanges traced within a customer complaint management system, etc.

However, the unstructured nature of these data makes it particularly difficult to exploit, at least fully automatically. In addition, laborious and time-consuming manual operations are often required to extract useful information from these textual data, such as a user's feeling (e.g. satisfaction or dissatisfaction) or the purpose and reasons for this feeling.

Textual data search techniques have of course been developed to facilitate these operations, but these existing solutions, which can be divided into two broad categories solutions based on an approach based on supervised learning on the one hand, and solutions based on an approach based on unsupervised learning on the other hand-generally have several drawbacks, as detailed below.

A major drawback of supervised learning approaches is that they require a particularly significant human investment to build a labeled learning base large enough to achieve reliable results. More precisely, each sample of such a learning base has to be manually annotated, which is extremely time-intensive. Another major drawback of these supervised learning-based solutions is that classification is performed based on predefined categories, i.e. pre-identified and pre-selected by a human operator. In other words, these solutions do not allow the automatic discovery of new categories (e.g. new feelings, new purposes of a feeling, etc.) that would appear over time and which would not have been identified manually from the outset in the learning base used.

Current approaches based on unsupervised learning only partially overcome some of the aforementioned drawbacks. Although they require less human investment overall than the one required to implement supervised learning solutions, this investment remains relatively significant, as the construction of a large learning base remains required (although it is not necessary to annotate it manually in this case).

Furthermore, regardless of the approach considered, it is also noticed that the level of granularity of results generated by existing solutions is often relatively coarse. For example, many of these existing solutions are limited to automatically determining a user's feeling or sensation, without necessarily providing information on the reasons that could explain that feeling. Therefore, significant human intervention is often still necessary even after the implementation of these automated solutions, in order to break down results obtained into finer levels of granularity and thus enable more interesting and relevant exploitation of the available textual data.

There is therefore a need for a solution for improving analysis of unstructured textual data collected via business applications or processes, especially by enabling the implementation of a more detailed automated analysis of these data.

### SUMMARY OF THE INVENTION

The present technique makes it possible to provide a solution for overcoming some drawbacks of prior art. According to a first aspect, the present technique is indeed directed to a method for analyzing a set of textual data, referred to as a set of verbatims, each verbatim comprising an ordered sequence of words, this method comprising:
a step of determining recurrent word combinations in said verbatims, and identifying common patterns within said recurrent word combinations;
a step of identifying synonymy relationships between words of a same syntax function within said common patterns, and gathering said synonymous words of the same syntax function within same data structures, referred to as semantic entities;
a step of determining typical actions according to said semantic entities, a typical action being representative of similar contexts of operations identifiable in said verbatims.

In this way, the present technique makes it possible to identify, from a set of verbatims, typical actions representative of various operation contexts detected in the verbatims. Thus, the present technique makes it possible to draw up, at a fine degree of granularity and in an unsupervised manner, a panorama of the different contexts of operations identifiable in a set of verbatims.

In one particular embodiment, said gathering into semantic entities further comprises taking derivation relationships and/or spelling corrections between words of said common patterns into account.

In this way, the present technique offers some flexibility when analyzing textual data, taking account of potential rephrasing or spelling errors in terms used in verbatims.

In one particular embodiment, said semantic entities comprise semantic entities of the verb, noun, or adjective type, and a typical action comprises a semantic entity of the verb type and at least one semantic entity of the noun or adjective type.

In this way, the semantic entities are categorized, allowing fine analysis of data identified in the verbatims, depending on whether they represent an object (noun-type semantic entity), an action (verb-type semantic entity), or a description (adjective-type semantic entity).

According to one particular characteristic of this embodiment, said method comprises associating said typical actions with said verbatims, a typical action being associated with a verbatim when a word combination present in said verbatim is associated with a common pattern comprising at least one word associated with the verb-type semantic entity of said typical action and at least one word associated with said at least one noun-or adjective-type semantic entity of said typical action.

In this way, the typical actions are linked to the verbatims within which they appear.

In one particular embodiment, said determining typical actions comprises identifying conditional relationships between said semantic entities, based on a probability of coexistence of words of said semantic entities within same verbatims.

In this way, complementary typical actions are identified based on dependency criteria identified in some verbatims.

According to one particular characteristic of this embodiment, said determining typical actions comprises constructing at least one graph according to said conditional relationships, and using said at least one graph to gather said typical actions into sub-themes, and said sub-themes into themes.

In this way, an automatic classification of the typical actions into sub-themes and themes is implemented, achieving a panorama of the different contexts of transactions identifiable in a set of verbatims with different degrees of granularity, comprising at least one fine degree of granularity (i.e. categorization into typical actions) and more general degrees of granularity (categorization into sub-themes and themes).

In one particular embodiment, said method further comprises a step of segmenting said verbatims into textual segments, and determining a polarity associated with each of said textual segments.

In this way, the present technique also makes it possible to associate different parts of the verbatims with categories of feelings expressed therein by users, among for example a negative feeling (i.e. the expression of dissatisfaction), a neutral feeling (i.e. neither satisfied nor dissatisfied), or a positive feeling (i.e. the expression of satisfaction).

According to one particular characteristic of this embodiment, said method comprises a step of weighting said typical actions, a typical action being weighted according to the polarities associated with the textual segments of the verbatims with which said typical action is associated.

In this way, the present technique makes it possible not only to establish a link between polarities and typical actions, i.e. between a user feeling and a reason for this feeling, but also to derive trends by taking account of the number of textual segments within which one particular feeling is associated with one particular reason.

According to another aspect, the present technique is also directed to an electronic device for analyzing a set of textual data, referred to as a set of verbatims, each verbatim comprising an ordered sequence of words, said device comprising:
means for determining recurrent word combinations in said verbatims, and for identifying common patterns within said recurrent word combinations;
means for identifying synonymy relationships between words of a same syntax function within said common patterns, and for gathering said synonymous words of the same syntax function within same data structures, referred to as semantic entities;
means for determining typical actions, according to conditional relationships identified between said semantic entities within said verbatims, a typical action being representative of similar contexts of operations identifiable in said verbatims.

The means of said electronic device may be adapted to the implementation of any of the embodiments of the method of the present application.

According to another aspect, the technique provided also relates to a computer program product downloadable from a communication network and/or stored on a computer-readable and/or microprocessor-executable medium, comprising program code instructions for executing an analysis method as described previously, when executed on a computer.

The technique provided is also concerned with a computer-readable recording medium on which a computer program is recorded comprising program code instructions for the execution of the steps of the method as previously described in any of its embodiments.

Such a recording medium may be of any entity or device capable of storing the program. For example, the medium can include a storage means, such as a ROM, for example a CD-ROM or a ROM of a microelectronics circuit, or also a magnetic storage means, for example a flash drive or a hard drive.

Besides, such a storage medium may be a transmissible medium such as an electrical or optical signal, which can be conveyed via an electrical or optical cable, by radio or by other means, so that the computer program contained therein is remotely executable. In particular, the program according to the invention may be downloaded on a network, for example the internet network.

The different above-mentioned embodiments can be combined together for the implementation of the invention.

### FIGURES

Other characteristics and advantages of the invention will appear more clearly upon reading the following description of a preferred embodiment, given merely as an illustrative and non-limiting example, and from the appended drawings, wherein:

FIG. 1 illustrates the main steps of a method for analyzing textual data, in one particular embodiment of the technique provided;

FIG. 2 sets forth an example of an oriented graph extract obtained in the scope of the analysis of a set of verbatims, in one particular embodiment of the technique provided;

FIG. 3 describes a simplified architecture of an electronic device for the implementation of the technique provided, in one particular embodiment.

### DETAILED DESCRIPTION OF THE INVENTION

The present application allows overcoming some of the aforementioned drawbacks.

More particularly, there is provided a technique for analyzing an unstructured corpus of textual data, automatically and in an unsupervised manner, in order to extract relevant information therefrom, for example business knowledge. Although this field of use is given by way of illustration and is not exhaustive, this technique is indeed advantageous for facilitating exploitation of data from logs generated at the level of business applications now widely deployed within companies (e.g. customer relationship management applications, incident management applications, etc.). The business knowledge extracted by this technique includes, for example, the identification of problems in the execution of certain business processes, the determination of feedback and/or the feelings of actors involved in these business processes (e.g. reasons for satisfaction or dissatisfaction), or even the determination of the recurrent nature of some business activities. The technique provided especially offers a better compromise than existing solutions, in that it allows data to be extracted at a relatively fine level of granularity while limiting the human investment (i.e. the number of manual non-automated operations) necessary to achieve this result.

As detailed in the following, in one particular embodiment, the technique provided also makes it possible to automatically structure information extracted, by organizing it into automatically identified sub-themes and themes. In other words, the present technique is not limited to raw data extraction, but it is also concerned with providing automatic structuring of the relevant data according to different levels of granularity, i.e. at different levels of generalization, thus making their exploitation easier.

According to a first aspect, the present technique is directed to a method for analyzing a set—or corpus—of textual data. More particularly, within the scope of the present technique, these textual data are designated under the generic term “verbatims”, a verbatim corresponding to a set of words entered by a user within for example a business application, with regard to one or more given objects (e.g. a job, an incident, a service, etc.). A verbatim can thus be assimilated to a coherent set of words, meaningful and based on structures specific to a language, allowing, for example, a user to express a feeling (negative, neutral or positive), but also possibly the purpose and reasons of this feeling. Such textual data are for example stored as text files or within dedicated fields of one or more databases.

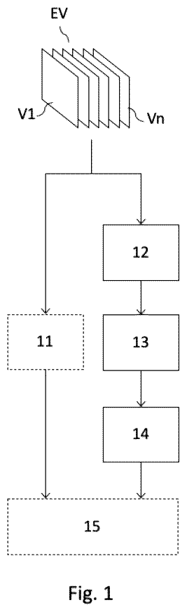

The general principle of a method for analyzing a set of verbatims, in one particular embodiment of the technique provided, is now set forth in connection with FIG. 1. Such a method is implemented by an electronic device having access to at least one data source comprising a set EV of verbatims (V1, . . . , Vn) to be processed.

In a step 12, determining recurrent word combinations within the verbatims is implemented, and then common patterns are identified within these word combinations. According to one particular characteristic, a common pattern gathers, for example, the semantically equivalent word combinations among the word combinations determined. In other words, step 12 aims to discover word combinations that are recurrent across all verbatims, and to perform gatherings of the word combinations that are used to express a same general idea, by associating them with a same common pattern.

Assuming, for example, that a recurrence of the following word combinations “troubleshoot a problem”, “settle my trouble”, “solve this problem”, “settle the problem”, “solve a trouble” is identified in the verbatims, the implementation of step 12 makes it possible to highlight that all these expressions form various semantic representations of a same idea—herein the resolution of a problem—by associating them with a same common pattern.

More particularly, two concepts (i.e. two groups of particular words) are identifiable in the previous example:
a first concept related to the action of finding a solution, characterized by the words “settle”, “solve”, and “troubleshoot”, associated with the syntax function “verb”;
a second concept related to the notion of difficulty, characterized by the words “problem”, and “trouble”, associated with the syntax function “noun”.

All the previous combinations can thus be gathered under a same common label, i.e. a same common pattern MC gathering a set of concepts, defined for example by a data structure which may take the following non-limiting form:
MC: {({‘settle’, ‘troubleshoot’, ‘solve’}, ‘verb’), ({‘problem’, ‘trouble’}, ‘noun’)}.

In one particular embodiment, step 12 is implemented via performing a succession of sub-steps comprising:
generating, for each verbatim of the set of verbatims, possible word combinations, referred to as candidate combinations, according to a predetermined distance threshold and a predetermined length threshold;
calculating the number of occurrences of each candidate combination in the set of verbatims, and filtering the candidate combinations according to their number of occurrences, such filtering may for example consist in removing the candidate combinations that do not appear sufficiently in the set of verbatims (i.e. whose number of occurrences is less than a predetermined threshold);
merging close candidate combinations (based, for example, on previous lemmatization operations of words of the candidate combinations);
determining all the synonymous words of each word of the candidate combinations, by means of a synonym dictionary (taking for example the form of a lexical database) accessible from the electronic device;
the use of determined synonymous words to identify common patterns for candidate combinations: more particularly, two candidate combinations are considered similar and gathered within a same group associated with a same common pattern when these two candidate combinations have a same number of words having the same syntax functions, and when for each word m1 of one of the two candidate combinations there is a word m2 in the other of the two candidate combinations such as the words m1 and m2 are synonymous.

Thus, several groups of candidate combinations, each associated with a common pattern, are obtained at the end of step 12.

In a step 13, data structures, called semantic entities, are constructed based on the common patterns identified in step 12. More particularly, a semantic entity means a data structure comprising a set of synonymous words with a same syntax function. Thus, step 13 comprises identifying, by means of a synonym dictionary, synonymy relationships between words of a same syntax function (verbs, nouns or adjectives) within the common patterns, and gathering synonymous words of the same syntax function per semantic entity.

According to one particular characteristic, the semantic entities comprise:
“verb” type semantic entities, also referred to as action entities, gathering the synonymous verbs identified in all the common patterns;
“adjective” type semantic entities, also referred to as description entities, gathering the synonymous adjectives identified in all the common patterns;
“noun” type semantic entities, also referred to as nominal entities, gathering the synonymous nouns identified in all the common patterns.

In one particular embodiment, constructing the semantic entities comprises, in addition to taking synonymy relationships into account, taking derivation relationships and spelling correction relationships between the words present within the common patterns into account.

More particularly, taking derivation relationships into account makes it possible to bring derived words closer to each other when implementing step 13. For example, if a common pattern comprises the word “resolve”, the derived word “resolution” is also considered for the creation of the semantic entities even if it has not been identified as such within the common patterns obtained at the end of step 12.

Similarly, taking spelling correction relationships into account allows an incorrectly spelled word to be brought closer to its correctly spelled equivalent when implementing step 13. For example, spelling approximations related to forgetting or incorrect accents, or substituting some characters associated with the same sound (e.g. ‘i’ and ‘y’, ‘c’ and ‘q’, ‘x’ and ‘c’, etc.), are also considered for the creation of semantic entities: for example, the words ‘problem’ and ‘probleme” are considered equivalent, and gathered into a same semantic entity.

Two examples of semantic entities likely to be obtained in step 13 are purely illustratively set forth hereinbelow.

In a first example, it is assumed, for example, that step 12 of identifying common patterns enabled the following concepts (or groups of words) to be highlighted, among others: {‘concern_question’, ‘question’, ‘difficulty_problem’, ‘questioning_question’, ‘probleme_question’, ‘trouble’, ‘problem_trouble’, ‘problem’, ‘questioning’}. Based on the relationships previously set forth (synonym, derivation, spelling correction), step 13 makes it possible to construct a semantic entity of the “noun” type EN in which the following different nouns are gathered, as identified as being synonymous:
EN: ‘difficulty_questioning_probleme_problem_trouble_question_concern’

In a second example, it is assumed, for example, that step 12 of identifying common patterns enabled the following concepts (or groups of words) to be highlighted, among others: {‘pleasant_kind’, ‘friendly’, ‘pleasant_kind_friendly’, ‘nice’, ‘pleasant’, ‘kind_friendly’, ‘likeable_friendly’, ‘kind_likeable_cordial_nice’, ‘kindly_friendly’}. Based on the relationships previously set forth (synonym, derivation, spelling correction), step 13 makes it possible to construct a semantic entity of the “adjective” type ED in which the following different adjectives are gathered, as identified as being synonymous:
ED: ‘pleasant_ kind_kindly_cordial_nice_likeable_friendly’

Thus, several semantic entities of different types are obtained at the end of step 13.

In a step 14, the semantic entities constructed in step 13 are used to determine typical actions representative of similar contexts of operations (or use) identifiable in the set EV of the verbatims analyzed.

According to one particular characteristic, a typical action comprises a semantic entity of the verb type and at least one semantic entity of the noun or adjective type.

More particularly:
the verb-type semantic entity (or action entity) defines the type of operation associated with the action (e.g. installation, modification, cancelation, etc.);
the semantic entity of the noun type (or nominal entity) defines the object that undergoes the effect of the type of operation performed (e.g. fiber, an appointment, etc.);
the semantic entity of the adjective type (or description entity) defines the way in which the type of operation has been performed (e.g. late, incorrect, etc.).

Several gathering modes can be used to determine typical actions.

Firstly, in one particular embodiment, a first gathering mode concerns the common patterns identified in step 12.

More particularly, it involves associating with a given typical action (i.e. gathering together) the common patterns which simultaneously comprise:
at least one word (i.e. a concept) belonging to or having a derivative belonging to the verb-type semantic entity of the considered typical action;
at least one other word (i.e. another concept) belonging to or having a derivative belonging to the semantic entity of the noun or adjective type of the typical action considered.

Thus, for example, according to this first gathering method:
the common patterns ‘install fiber’ and ‘installation fiber’ are associated with the same typical action, because the word ‘installation’ is part of the derivatives of the verb-type semantic entity (i.e. of the action entity) comprising the verb ‘install’;
the common patterns ‘answer questioning’ and ‘problem response’ are associated with a same typical action, because on the one hand the word ‘response’ is part of the derivatives of the semantic entity of the verb type (i.e. of the action entity) comprising the verb ‘answer’, and on the other hand the words ‘questioning’ and ‘problem’ belong to the same semantic entity of the noun type (i.e. to the same nominal entity).

Secondly, in another particular embodiment complementary or alternative to the previous one, a second gathering method is carried out, based on conditional relationships between semantic entities, identified within the verbatims. According to one particular characteristic, these conditional relationships between semantic entities are identified according to a probability of coexistence of words of said semantic entities within same verbatims.

In this scope, two types of conditional relationships are, for example, considered:
so-called global conditional relationships, characterizing the identification of dependency relationships between semantic entities of the noun or adjective type within same verbatims;
so-called contextual conditional relationships, characterizing the identification of dependency relationships between semantic entities of the noun or adjective type within same verbatims, in the presence of one particular semantic action entity.

According to one particular characteristic, a conditional relationship between two semantic entities of the noun or adjective type is considered to be confirmed when the probability of coexistence of words of said semantic entities within same verbatims is greater than some predetermined threshold, for either of the two types of conditional relationships set forth previously.

Based on the conditional relationships identified, new typical actions are determined, a typical action comprising on the one hand all the semantic entities of the noun or adjective type that are linked by global or contextual conditional relationships associated with the presence of a same verb-type semantic entity, and on the other hand the verb-type semantic entity in question. An association of some common patterns to these new typical actions is also implemented, a common pattern being associated with a given typical action when it comprises:
at least one word (i.e. a concept) belonging to or having a derivative belonging to the semantic entity of the verb type of the typical action considered;
at least one other word (i.e. another concept) belonging to or having a derivative belonging to a semantic entity of the noun or adjective type of the typical action considered.

In one particular embodiment, determining the typical actions comprises constructing at least one graph based on the conditional relationships identified, and using this graph to gather the typical actions into sub-themes, and the sub-themes into themes.

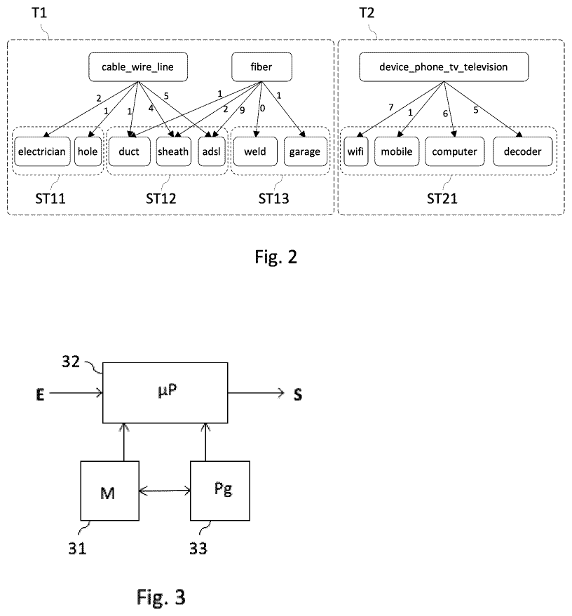

An example of an extract of such a graph is set forth in connection with FIG. 2, in one particular embodiment of the technique provided. This oriented graph is for example constructed from the global conditional relationships previously identified. More particularly, in this example given for purely illustrative purposes, each node of the graph corresponds to a noun type semantic entity, and each oriented link between two nodes corresponds to a global conditional relationship identified between the corresponding nodes. Each link is also associated with a weight, corresponding to the number of times the linked nodes have formed contextual conditional relationships together in the context of different verb-type semantic entities (i.e. of actions entities). For example, if in all the verbatims analyzed the nominal semantic entities “fiber” and “sheath” are always associated together in the presence of either of the action entities associated with the verbs “install” and “check”, the weight “2[ is associated with the link between these two nominal semantic entities, representative of the fact that two operation (or use) contexts distinct have been identified in the verbatims related to these nominal semantic entities (i.e. one context in which these objects are mentioned as part of an installation operation, and another context in which these objects are mentioned as part of a check operation).

A graph constructed in this way is interesting in that it can be used to automatically determine possible gatherings between semantic entities of a same type (and more particularly of the noun or adjective type), at different levels of granularity.

Thus, based on predetermined rules, such a graph makes it possible, for example, to identify sub-themes, a sub-theme being representative of a set of semantic entities of the noun or adjective type that coexist in the same verbatims (without necessarily being the subject of the same action entities), or stated differently, that share the same context of operation.

According to a construction example, a sub-theme gathers, for example, all child nodes that descend exactly from the same parent nodes.

For example, when applied to the graph extract illustrated in FIG. 2, such a construction rule allows automatically obtaining (i.e. without the intervention of a user) of four sub-themes:
the sub-theme ST11 comprising the nominal semantic entities “electrician” and “hole” having as parent node the nominal semantic entity “cable_wire_line”;
the sub-theme ST12 comprising the nominal semantic entities “duct”, “sheath” and “adsl” having as parent nodes the nominal semantic entities “fiber” and “cable_wire_line”;
the sub-theme ST13 comprising the nominal semantic entities “weld” and “garage” having as parent node the nominal semantic entity “fiber”;
the sub-theme ST21 comprising the nominal semantic entities “wifi”, “mobile”, “computer” and “decoder” having as parent node the nominal semantic entity “device_phone_tv_television”.

Possibly, an additional rule excluding from a sub-theme the child nodes associated with a zero weight link is also applied (such a rule implemented in the scope of the previous example then leading, for example, to the exclusion of the nominal semantic entity “weld” of the sub-theme ST13, the weight of the link between the semantic entity “weld” and its parent the semantic entity “fiber” being zero).

According to one particular characteristic, the sub-themes thus identified are in turn gathered into themes, based on a predetermined rule.

According to a construction example, a theme is for example defined by the union of the sub-themes sharing parent nodes in common.

For example, when applied to the graph extract illustrated in FIG. 2, such a construction rule allows automatically obtaining (i.e. without the intervention of a user) of two themes:
the theme T1 gathering the sub-themes ST11, ST12 and ST13 which have as parent nodes the nominal semantic entities “fiber” and/or “cable_wire_line”;
the theme T2 comprising the sub-theme ST21 which has as parent node the nominal semantic entity “device_phone_tv_television”.

Thus, the implementation of steps 12, 13 and 14 allows the identification, from a set of verbatims, of typical actions representative of various operation contexts detected in the verbatims, and their automatic classification into sub-themes and themes. In other words, the present technique makes it possible to draw up, according to an unsupervised approach, a panorama of the different contexts of transactions identifiable in a set of verbatims, at different degrees of granularity, comprising at least one fine degree of granularity (i.e. categorization into typical actions) and more general degrees of granularity (categorization into sub-themes and themes).

In one particular embodiment, the analysis method according to the present technique also comprises, for example in parallel with steps 12, 13 and 14, a step 11 comprising segmenting the verbatims into textual segments, and determining a polarity associated with each of said textual segments. Polarity here means an attribute representative of a sensation and/or an emotional state associated with the textual segment considered. Such an attribute can, for example, qualify the expression within the textual segment considered of satisfaction or, on the contrary, of dissatisfaction of a user, possibly to different degrees.

The segmentation of a verbatim is carried out automatically (i.e. without manual intervention), for example based on punctuation characters present in the verbatim (e.g. commas, semicolon, dots, etc.). According to one particular characteristic, segmentation also takes predefined textual separators into account, including for example keywords conventionally used to introduce a notion of contradiction (e.g. the words “however”, “on the contrary”, “but”, “nevertheless”, “on the other hand”, etc.).

At the end of step 11, each textual segment is thus associated with a polarity or category of feeling among, for example, the following categories: a negative feeling (i.e. the expression of dissatisfaction), a neutral feeling (i.e. neither satisfied nor unsatisfied), a positive feeling (i.e. the expression of satisfaction). According to one particular characteristic, the determination of polarities associated with textual segments relies on the use of a pre-trained BERT (Bidirectional Encoder Representations from Transformers) language model to perform sensation analysis operations.

In one particular embodiment, in a step 15, typical actions obtained at the end of steps 12, 13 and 14 are weighted according to the polarities associated with the textual segments as identified in step 11. In other words, insofar as the technique provided makes it possible to associate a textual segment with a typical action on the one hand and a polarity on the other hand, it is possible to establish a link between polarities and typical actions, i.e. between a user feeling and a reason (or cause) of this feeling. More particularly, the technique provided makes it possible to derive trends at a fine level of granularity, by taking account of the number of textual segments within which one particular feeling is associated with one particular reason.

According to one particular characteristic, the typical actions being furthermore organized into automatically determined sub-themes and themes, the present technique also makes it possible in one embodiment to establish a tree structure (for example in the form of a graph) of the typical actions by sub-themes and themes according to each type of polarity identified.

Such a tree structure can in particular serve as a foundation for the construction of a graphical interface allowing a user to explore at different levels of granularity, feelings and reasons for feelings automatically extracted from a set of verbatims, thereby greatly facilitating exploitation thereof. It can also be used to automatically generate various summary reports related to business applications (especially in the field of customer relationship management), such as satisfaction reports, for example.

According to another aspect, the present technique also relates to an electronic device for analyzing a set of textual data, referred to as a set of verbatims, this device being able to implement the method previously described in any of its embodiments. More particularly, such an electronic device comprises:
means for determining recurrent word combinations in said verbatims, and for identifying common patterns within said recurrent word combinations;
means for identifying synonymy relationships between words of a same syntax function within said common patterns, and for gathering said synonymous words of the same syntax function within same data structures, referred to as semantic entities;
means for determining typical actions, according to conditional relationships identified between said semantic entities within said verbatims, a typical action being representative of similar contexts of operations identifiable in said verbatims.

FIG. 3 schematically represents, in a simplified manner, the structure of such an electronic device, in one particular embodiment. In one particular embodiment, this electronic device takes for example the form of a processing server connected via a communication network to at least one remote data source within which verbatims are stored, or even a processing server itself hosting one or more business applications likely to generate verbatims.

The electronic device according to the technique provided comprises for example a memory 31 consisting of a buffer memory M, a processing unit 32, equipped for example with a microprocessor μP, and driven by the computer program Pg 33, implementing the analysis method according to the invention.

Upon initialization, the code instructions of the computer program 33 are loaded into the buffer memory before being executed by the processor of the processing unit 32. The processing unit 32 receives as an input E a set of textual data, or set of verbatims, each verbatim comprising an ordered sequence of words.

The microprocessor of the processing unit 32 then performs the steps of the previously described method, according to instructions of the computer program 33, to deliver as an output S data comprising at least one set of typical actions representative of similar contexts of operations identifiable in said verbatims. In one particular embodiment, the output S takes for example the form of a structured dataset in which the typical actions are gathered by sub-themes, and the sub-themes by themes, according to different types of associated polarities (or feeling, e.g. negative, neutral, or positive) identified in the set of verbatims.

1. an analysis method for analyzing a set of textual data, referred to as a set of verbatims, each verbatim comprising an ordered sequence of words, said method being implemented by an electronic device, said method comprising:
receiving as input the set of verbatims;
segmenting said verbatims into textual segments, and determining a polarity associated with each of said textual segments;
determining recurrent word combinations in said verbatims, and identifying common patterns within said recurrent word combinations;
identifying synonymy relationships between words of a same syntax function within said common patterns, and gathering said synonymous words of the same syntax function within same data structures, referred to as semantic entities;
determining typical actions according to said semantic entities, a typical action being representative of similar contexts of operations identifiable in said verbatims;
weighting said typical actions, each typical action being weighted according to the polarities associated with the textual segments of the verbatims with which said typical action is associated; and
outputting at least one set of the typical actions and associated polarities, based on said weighting.

2. The analysis method according to claim 1, wherein said gathering into semantic entities further comprises taking derivation relationships and/or spelling corrections between words of said common patterns into account.

3. The analysis method according to claim 1, wherein said semantic entities comprise semantic entities of the verb, noun, or adjective type, and wherein each typical action comprises a semantic entity of the verb type and at least one semantic entity of the noun or adjective type.

4. The analysis method according to claim 3, wherein the method comprises associating said typical actions with said verbatims, each typical action being associated with a verbatim when a word combination present in said verbatim is associated with a common pattern comprising at least one word associated with the semantic entity of the verb type of said typical action and at least one word associated with said at least one semantic entity of the noun or adjective type of said typical action.

5. The analysis method according to claim 1, wherein said determining typical actions comprises identifying conditional relationships between said semantic entities, based on a probability of coexistence of words of said semantic entities within same verbatims.

6. The analysis method according to claim 5, wherein said determining typical actions comprises constructing at least one graph according to said conditional relationships, and using said at least one graph to gather said typical actions into sub-themes, and said sub-themes into themes.

7. An electronic device for analyzing a set of textual data, referred to as a set of verbatims, each verbatim comprising an ordered sequence of words, said device comprising:
an input for receiving the set of verbatims;
an output;
at least one processor; and
at least one non-transitory computer readable medium comprising instructions stored thereon which when executed by the at least one processor configure the electronic device to:
segment said verbatims into textual segments, and determining a polarity associated with each of said textual segments;
determine recurrent word combinations in said verbatims, and for identifying common patterns within said recurrent word combinations;
identify synonymy relationships between words of a same syntax function within said common patterns, and for gathering said synonymous words of the same syntax function within same data structures, referred to as semantic entities;
determine typical actions, according to conditional relationships identified between said semantic entities within said verbatims, a typical action being representative of similar contexts of operations identifiable in said verbatims;
weight said typical actions, each typical action being weighted according to the polarities associated with the textual segments of the verbatims with which said typical action is associated; and
outputting on the output at least one set of the typical actions and associated polarities, based on said weighting.

8. A non-transitory computer readable medium comprising a computer program product stored thereon comprising program code instructions for the execution of a method for analyzing a set of textual data, when the instructions are executed by at least one processor, wherein the set of textual data is referred to as a set of verbatims, each verbatim comprising an ordered sequence of words, and wherein the method comprises:
receiving as input the set of verbatims;
segmenting said verbatims into textual segments, and determining a polarity associated with each of said textual segments;
determining recurrent word combinations in said verbatims, and identifying common patterns within said recurrent word combinations;
identifying synonymy relationships between words of a same syntax function within said common patterns, and gathering said synonymous words of the same syntax function within same data structures, referred to as semantic entities;
determining typical actions according to said semantic entities, a typical action being representative of similar contexts of operations identifiable in said verbatims;
weighting said typical actions, each typical action being weighted according to the polarities associated with the textual segments of the verbatims with which said typical action is associated; and
outputting at least one set of the typical actions and associated polarities, based on said weighting.
